(19) United States
(12) Patent Application Publication
(10) Pub. No.: US 2022/0236163 A1
(43) Pub. Date: Jul. 28, 2022

(54) Device And Method For Detecting A Concentration Of Predetermined Particles On The Basis Of Their Morphological Properties In Air

(71) Applicant: ebm-papst neo GmbH & Co. KG, Mulfingen (DE)

(72) Inventors: Frederik Wystup, Neuenstein (DE); Ralph Wystup, Kunzelsau (DE)

(21) Appl. No.: 17/585,025

(22) Filed: Jan. 26, 2022

(30) Foreign Application Priority Data
Jan. 28, 2021 (DE) 102021101982.6

(51) Int. Cl. G01N 15/06; G01N 23/2251

(52) U.S. Cl. CPC G01N 15/06; G01N 23/2251; G01N 2223/507; G01N 2223/418; G01N 2223/07

(57) ABSTRACT

A device (1) for detecting a concentration of predetermined particles, particularly viruses, in air (3) with organic and/or inorganic aerosol particles, has a supply unit (10), an imaging unit (20), an image acquisition unit (40) and an evaluation unit (50). The supply unit (10) binds the aerosol particles as particles in a fluid (4). The imaging unit (20) operates on the functional principle of a scanning electron microscope in order to generate an enlarged image of the particles contained in the fluid (4). The image acquisition unit (40) acquires and transmits the image. The evaluation unit (50) evaluates the particles depicted in the image. The evaluation unit (50) automatically detects morphological properties of the particles depicted in the image and compares the detected morphological properties with morphological properties of the predetermined particles. Through the comparison, it determines a proportion and/or number of predetermined particles in the image and the concentration of the predetermined particles in the air (3).

### CROSS-REFERENCE TO RELATED APPLICATION

This application claims the benefit and priority of German Application No. 10 2021 101 982.6, filed on Jan. 28, 2021. The entire disclosure of the above application is incorporated herein by reference.

### FIELD

The disclosure relates to a device and to an associated method to detect a concentration of predetermined particles and, in particular, viruses in air on the basis of their morphological properties and, in particular, their visual nature, more particularly their external appearance.

### BACKGROUND

A multitude of diseases and pathogens and, in particular, disease-causing viruses exist that spread via the air and particularly via aerosols. Thus, they are present in the air as aerosol particles. It is therefore desirable to be able to detect such viruses in the air and to be able to determine their concentration in the air and thus a possible risk of infection.

In the prior art, while very precise methods to determine the concentration of viruses in the air are known, they are based predominantly on laboratory methods that involve correspondingly lengthy analyses. Thus, the known methods are complex, expensive and, above all, time-consuming. The devices for carrying out the known methods cannot be used to provide short-term warning about pathogens. This is since the analysis results would usually simply be available too late.

In addition, the known methods are mostly tailored to a single, very specific virus or generally to a single, specific pathogen and often cannot be used for other pathogens. Thus, the concentration or presence of various pathogens in the air cannot be determined using such methods.

For an initial assessment of whether pathogens are present in the air, as well as an assessment of the danger posed by potentially existing pathogens, it is often not absolutely necessary at first to know exactly which pathogens or viruses are involved, but only that such pathogens are present with a certain probability and with or in a certain concentration. For example, the previously unpublished German patent applications with application numbers 10 2020 120 199.0 and 10 2020 124 740.0 suggest various solutions by determining the presence of particles with a certain particle size that are most likely to represent certain pathogens.

It should be noted that an aerosol is a heterogeneous mixture (dispersion) of solid and/or liquid suspended particles in a gas, e.g., air. The suspended particles are referred to as aerosol particles, and such aerosol particles can be dust, pollen, spores, bacteria, or viruses, for example. This means that a simple measurement of the aerosol particles, and thus an assessment of whether pathogens, are present is not readily possible.

Particularly when determining the concentration of particles in the air on the basis of the size of the particles, particles may be included in the determination of the concentration that happen to be of a similar size and do not correspond to the pathogen being sought. Thus, this renders the determined concentration inaccurate.

### SUMMARY

It is therefore an object of the disclosure to overcome the aforementioned drawbacks by providing a device and an associated method where the concentration of certain particles and, in particular, certain viruses in the air can be determined quickly and with a high level of accuracy.

This object is achieved by a device for detecting a concentration of predetermined particles, particularly viruses, in air that includes organic and/or inorganic aerosol particles. The device comprising a supply unit, an imaging unit, an image acquisition unit, and an evaluation unit. The supply unit binds the aerosol particles contained in the air in a fluid. The fluid contains aerosol particles that were previously contained in the air as particles. A constant or uniformly clocked fluid flow passes along a predetermined flow path. The imaging unit has a sample channel. The interior can be flowed through by the fluid and determines the predetermined flow path within the image unit. The imaging unit scans the particles in the fluid in the sample channel in a raster pattern using an electron beam as the primary electron beam, to capture electrons that are designated as secondary electrons through interaction of the electron beam with the particles. Via the captured electrons, it generates an enlarged image of the particles that are contained in the fluid flowing through the sample channel. The image acquisition unit acquires the image and transmit the image to the evaluation unit. The evaluation unit automatically acquires morphological properties of the particles shown in the image. It compares the detected morphological properties with morphological properties of the predetermined particles. It determines a proportion and/or a number of predetermined particles in the image and the concentration of the predetermined particles in the air by comparison.

According to the disclosure, a device is proposed to detect a concentration of predetermined particles, in particular viruses, in the air. The air comprises organic and/or inorganic aerosol particles. The device has a supply unit, an imaging unit, an image acquisition unit, and an evaluation unit. The supply unit is designed to bind the aerosol particles contained in the air in a fluid. Thus, the fluid contains the aerosol particles previously contained in the air as particles. The fluid is preferably a liquid, and the fluid can also be a gas mixture. A provision is additionally made that the supply unit is designed to provide a constant or uniformly clocked fluid flow along a predetermined flow path. Accordingly, it is possible for the fluid flow to be conveyed continuously along the flow path, both in the case of a constant supply and of a clocked supply. The supply unit is preferably fluidically connected to the imaging unit with respect to the flow path. Thus, the fluid or the liquid is able to flow along the flow path from the supply unit into and through the imaging unit. The imaging unit has a sample channel with an interior space through which the fluid or the fluid flow can pass continuously or in cycles. The sample channel determines the predetermined flow path within the imaging unit. The sample channel can also be referred to here as a measuring chamber. The imaging unit is designed to scan the particles in the fluid in the sample channel in a raster pattern with an electron beam (primary electron beam). This detects electrons (secondary electrons) generated by the interaction of the electron beam (primary electron beam) with the particles. This creates an enlarged image using the detected electrons (secondary electrons) of the particles contained in the fluid that is flowing through the sample channel. The imaging unit can be embodied as a scanning electron microscope or function according to the functional principle of such a microscope. Furthermore, the imaging unit can also be embodied as an atmospheric scanning electron microscope. Both in the case of continuous and cyclical conveyance, a fluid including the particles is located in the imaging unit. Thus, an “in-situ measurement” or “in-situ analysis” can be carried out by enlarging the particles where the sample, formed by the fluid flowing through the sample channel, can change continuously (either in a clocked or continuous manner). This means, in particular, that it is not necessary to exchange or adapt the sample, a sample carrier, or other components of the device by hand. In order to enable a quick and automatic analysis or evaluation of the images obtained by imaging unit. The image acquisition unit acquires the image, particularly by imaging technology. The image is transmitted in its acquired form or digitally to the evaluation unit. Accordingly, the evaluation unit automatically detects morphological properties of the particles that are depicted in the image. The detected morphological properties are compared with morphological properties of the predetermined particles. The comparison determines a proportion and/or a number of predetermined particles in the image and the concentration of the predetermined particles in the air. Morphological properties are understood to refer particularly to the appearance of the particles or the viruses. Thus, the predetermined particles can be or are distinguished from other particles on the basis of their appearance. The concentration can be specified, for example, as the number of predetermined particles per predetermined air volume—per cubic meter, for example.

On the basis of the concentration of the predetermined particles (viruses) in the sample or in the fluid and the concentration of the predetermined particles (viruses) in the air from the obtained sample, the evaluation unit can also determine, categorically, whether certain particles (viruses) are present, how high the risk of infection is, and whether the risk of infection exceeds a predetermined threshold value.

In addition to the concentration of the predetermined particles, concentrations of other particles can also be detected. For example, a plurality of predetermined particles can also be specified. For example, a first predetermined particle corresponds to a first virus or first pathogen. Also, a second predetermined particle corresponds, for example, to a second virus or second pathogen. Thus, the evaluation unit can be used to determine which concentrations of the first predetermined particle and second predetermined particle are present. Accordingly, the morphological properties of both particles or, in the case of a plurality of predetermined particles, of all predetermined particles are then known in advance and stored for this purpose in the evaluation unit. In addition to pathogens or the like, the evaluation unit can also determine the concentration of dust in the air, for example, since dust is also simply particles in the air.

Based on the detection, an alarm can also be triggered. Additionally, a signal can be transmitted to connected systems using signaling technology. Thus, a concentration is to be transmitted and a warning of a risk of infection is to be issued as required.

As was described in the introduction, methods and associated devices are generally known where viruses or particles can be detected in a sample taken from the air. However, these detections can usually only be utilized under laboratory conditions and by specialist personnel. The detections are not suitable for continuous control and checking of the air, particularly ambient air. Therefore, it is a basic idea of the disclosure to provide a possibility through the device where a continuous or continuously clocked sample flow (fluid flow) can be continuously analyzed. This enables detection and at least the display of the concentration of viruses (particles) in the (ambient) air.

On the input side of the supply unit, the air can be sucked in at a predetermined volumetric flow rate, for example, by a suction device and, in particular, a fan or blower.

In order to enable meaningful conclusions to be drawn regarding the concentration of the predetermined particles in the air, the supply unit binds the aerosol particles contained in a predetermined volume of the air to the fluid in a predetermined volume. Thus, the concentration of the predetermined particles in the predetermined volume of air can be determined from the proportion of predetermined particles in the predetermined volume of the fluid. It therefore holds true that predetermined particles that are preferably contained in a defined volume of air are present in a defined and known volume of fluid after being bound in the fluid.

However, the predetermined particles can be present in the fluid in a very low concentration. Thus, the solution of fluid and particles can be very “thin.” In order to increase the concentration in a certain region of the sample—i.e., in a certain region of the fluid that is flowing through the sample channel—and thereby simplify the evaluation, the fluid or the liquid is an electrolyte solution containing an electrolyte. The supply unit and/or the imaging unit has an isotachophoresis device generating an electric field. The isotachophoresis device separates the particles bound in the electrolyte solution from one another portion-wise by their different ion mobility. Thus, the fluid flowing through the sample channel has portions where particles with the same ion mobility are concentrated. Thus, there is a region in the sample where the predetermined particles are present in a higher concentration than in the surrounding regions of the fluid. Also, there is a region where substantially all of the predetermined particles of the sample are present, since they have an identical ion mobility. Before and after this region, there are additional regions where other particles contained in the sample, with different ion mobilities are present in an elevated concentration. Thus, the imaging unit can enlarge, in a targeted manner the region of the sample with the increased concentration of the predetermined particles. Alternatively, substantially the entire sample can be enlarged. The isotachophoresis device can also have two voltage terminals for this purpose. A first terminal is arranged on the fluidic input side of the imaging unit. A second terminal is arranged on the fluidic output side of the imaging unit. Thus, voltage or an electric field can be applied to the fluid within the sample channel.

In order to enable the fluid flow to be driven from the supply unit through the sample channel, in another design variant, the device further comprises a pump. The pump drives the fluid flow along the flow path. It pumps or conveys the liquid or the fluid from the supply unit at a preferably constant volumetric flow rate or in a continuous cycle through the imaging unit.

In order to improve the visibility of the predetermined particles or of all of particles in the sample or the fluid flowing through the sample channel, the supply unit is designed to mix a contrast medium into the fluid. Thus, in particular, negative contrasting can be implemented. Accordingly, the particles or the shape and external appearance of the particles, in the image generated by the imaging unit, are more visible or recognizable. The contrast medium can, in particular, be phosphotungstic acid.

The analysis or evaluation of the sample can be further simplified by having the sample contain fewer particles that are not to be detected anyway and that therefore deviate from the predetermined particle. To achieve this advantageously, the supply unit has an inlet-side pre-filter designed to filter air flowing into the supply unit on the inlet side. Thus, organic and/or inorganic aerosol particles contained in the air, that are not the predetermined particles, are at least partially filtered out before the binding of the aerosol particles in the fluid. Thus, they are not present in the fluid. Since the most important types of predetermined particles have a diameter of less than 300 nm, size filtering in particular merits consideration as a pre-filter where all particles are filtered out that have a diameter greater than 300 nm.

The pre-filter can also have a plurality of filters that can also be based on different filtering principles. For example, the pre-filter can have a size filter where preferably, substantially all aerosol particles with a diameter greater than the diameter of the predetermined particles are filtered out. Thus, filtered air is obtained that preferably contains only aerosol particles with a diameter that is the same and/or less than the diameter of the predetermined particles. This means that, during the binding of the aerosol particles contained in the air in the liquid or the fluid, the liquid or the fluid contains the aerosol particles previously contained in the filtered air as particles with a diameter that is equal to or less than the diameter of the predetermined particle.

Guiding the air into the size filter enables the concentration to then be determined with greater precision since there are fewer “disruptive” particles in the fluid that might falsify the measurement results. Such a size filter can also include a plurality of filters that are arranged one behind the other. Thus, the size filter can essentially be a filter arrangement where successive particles, with a diameter that is greater than the diameter of the predetermined particles, can be filtered before the remaining particles are bound in the fluid.

Since depending on the pathogen to be detected (predetermined particle or virus), there are charged and/or uncharged particles in the air, whose concentration should preferably not be determined, in another advantageous variant the pre-filter has a charge filter. Here, aerosol particles that have a positive charge and/or aerosol particles that have a negative charge and/or aerosol particles that are uncharged are filtered out of the air. Thus, filtered air is obtained that preferably contains only aerosol particles with a predetermined charge corresponding to a charge of the predetermined particles. Here, “charge” can be understood to refer to a positive charge, a negative charge, and no charge. This means that, when the aerosol particles contained in the air are bound, the fluid substantially only contains the aerosol particles previously contained in the filtered air with a predetermined charge as particles, that can be achieved, for example, by a linear mass spectrometer with quadruple electrodes.

To implement such a charge filter, an electric field can be used. Here, the charged (aerosol) particles are deflected from their path of movement and removed from the air flow. A charge filter implemented in this manner can also be combined with one or more size filters.

The charge filter can also be embodied as an electrostatic filter column or electrostatic filter.

In addition, the pre-filter or a filter of the pre-filter can be embodied as an “impaction” filter where the air flowing in, on the inlet side, or in general, the air flow is deflected. Thus, particles to be removed that are larger than the predetermined particles are separated from the air flow as a result of the greater mass and the momentum inherent in the particles.

A provision can also be made that the pre-filter has or provides an inhomogeneous electric field where polarizable aerosol particles are polarized. Furthermore, the inhomogeneous electric field or a device generating this field directs the polarized aerosol particles through the inhomogeneous course of the electric field onto a collecting device or deflects them from their movement path and collect them at the collecting device. Accordingly, the polarized aerosol particles collect on or at the collecting device and are bound there or starting from there when the aerosol particles contained in the air are bound in the fluid.

For example, the collecting device can be the capacitor of the supply unit, that will be discussed later. It can be appropriately temperature-controlled such that the polarized aerosol particles condense on the collecting device. The guiding of the air through the inhomogeneous electric field which, accordingly, substantially represents a filtering and collecting of the polarizable particles from the air, can be combined with an upstream charge filter and one or more upstream size filters.

If the predetermined particles are not polarizable but have a known charge, the collecting device can also be embodied as an appropriately oppositely charged surface that attracts the predetermined particles and the known charge. Such appropriately oppositely charged surfaces, provided as a collecting device, can also be heated.

To bind the particles in the fluid, the supply unit has a capacitor to bind the aerosol particles contained in the air in the fluid or liquid by condensation. The air, with the particles it contains, can thus condense on the condenser to form a condensate (condensation water) and be discharged therefrom. The condenser, for example, can be temperature-controlled. This leads to the formation of condensed water. The condenser embodied as a Peltier element.

The imaging unit preferably functions on the principle of a scanning electron microscope, that can be referred to as a SEM for short. According to one advantageous embodiment, the imaging unit functioning as a SEM further comprises a primary electron source that generates a primary electron beam; a plurality of magnets that direct the primary electron beam and act as a lens for the primary electron beam; and a vacuum chamber where there is a vacuum and where the primary electron beam passes. Furthermore, the imaging unit has at least one raster device to deflect the primary electron beam in a raster pattern, as well as, a detector to detect secondary electrons. In order to enlarge the particles contained in the sample, the sample channel preferably runs through the vacuum chamber or is adjacent thereto. The sample channel is arranged in or on the vacuum chamber in such a way that the primary electron beam strikes the sample channel and the fluid flowing, particularly continuously, through the sample channel. Thus, that secondary electrons are generated in the process. Although there is a vacuum or very low air pressure in the vacuum chamber, overpressure or atmospheric pressure can be present in the sample channel.

If the particles contained in the air are bound in (conventional) water or another electrically conductive liquid, preparation of the sample to that effect can be omitted, since it or the fluid is already conductive.

The primary electron beam, which preferably has a diameter between approx. 1 nm and 10 nm, can accordingly be scanned in a raster pattern over a predetermined raster section on the sample channel. Thus, the primary electron beam scans the sample, generating the secondary electrons and the enlarged image according to known functional principle of a SEM is built up line by line.

Since a SEM is used, the sample channel should be at least partially transparent or almost completely permeable to the primary electron beam generated by the SEM. Thus, in one advantageous variant, the sample channel is at least partially made of silicon nitride, a preferably thin aluminum foil, or another material that is permeable to the primary electron beam and/or to the electrons of the primary electron beam and the secondary electrons. The silicon nitride, the aluminum foil, or the other suitable material simultaneously seals the interior of the sample channel off from the vacuum chamber in a pressure-tight manner.

Furthermore, the sample channel can have a raster section on a side facing toward the primary electron beam over which the primary electron beam is scanned and guided by the raster device. In the raster section and preferably over the entire raster section, the sample channel is made of silicon nitride, aluminum foil, or another material that is permeable to the primary electron beam and the secondary electrons. The material simultaneously seals the interior of the sample channel off from the vacuum chamber in a pressure-tight manner.

The sample channel can also have a plurality of window-like sections made of the material that the primary electron beam can pass through.

In addition, the sample channel can include of one, two, or more mutually adjacent membrane(s) forming a channel between them. The membrane adjoining the vacuum chamber and/or facing toward the primary electron beam is passable for the primary electron beam and the secondary electrons. It is made, for example, of silicon nitride or another suitable material.

Furthermore, the sample channel or the section of the sample channel where the primary electron beam can pass is preferably selected with regard to its thickness in such a way that the SEM is able to produce an image or magnification that is as precise and sharp as possible.

Compared to a conventional SEM, the presently proposed SEM can be advantageously embodied such that it is specially designed for the preferably constant magnification of a constantly or cyclically changing but similar sample at a previously known and unchangeable position but requires no exchanging of a sample carrier or the like in order to be changed. Thus, the SEM proposed according to the advantageous variant does not have to be designed to be substantially focusable or generally adjustable, nor does it have to take a specimen holder into account or enable the same to be changed for the samples. Accordingly, the magnets are embodied as permanent magnets or as electromagnets and are supplied with a constant or substantially unchangeable voltage. Thus, the primary electron beam is focused by the magnets in a single, predetermined manner on the fluid flowing through the sample channel. In particular, it can be guided over the raster section of the sample channel in a raster pattern by the raster device. Alternatively, the magnets can also be provided in the form of coils. Furthermore, these are arranged particularly as ring magnets around the vacuum chamber. If electromagnets with a constant voltage are provided, there is no need for complex voltage regulation and associated control. In addition, a SEM usually comprises a plurality of magnets or magnet systems formed by the same. Thus, for example, depending on the required magnetic field, first magnets of the SEM can be embodied as permanent magnets. The second magnets of the SEM can be embodied as electromagnets that are supplied with a constant voltage. If the SEM comprises an aperture, this can also be invariable or fixed. The electron source can also be designed to generate an invariable or fixed electron beam with constant, predetermined properties.

As described, the proposed SEM is preferably not substantially adjustable. However, a provision can be made where the SEM or the individual components of the SEM can be set in a narrowly delimited and predetermined range in order to enable fine adjustment, focusing of the generated image, and compensation for aging phenomena. For this purpose, the magnets can be exchangeable, for example, or a possibly existing aperture can be adjustable to a very limited extent.

In addition, the sample channel can be connected to the vacuum chamber permanently and, relative to the vacuum chamber, particularly in a stationary manner. A one-piece design of the vacuum chamber and sample channel together where these are inseparably connected is also advantageous.

Furthermore, with this special variant, the vacuum chamber of the SEM does not have to be designed to repeatedly build up a high vacuum. Therefore, the vacuum chamber can be completely pressure-tight and also designed to permanently maintain a vacuum prevailing therein. Thus, a pressure reduction that determines the vacuum only needs to be carried out once, e.g., during the manufacture or fabrication of the device or vacuum pressure chamber. It remains intact permanently, i.e., preferably over the entire service life of the device.

The raster device is preferably also designed to deflect the primary electron beam electrostatically and/or electromagnetically. Thus, it guides it in a raster pattern over the sample channel and particularly over the raster section of the sample channel.

In order to capture and, particularly, digitize the generated image, the image acquisition unit is preferably an A/D converter. It is designed to convert an analog image captured by secondary electrons by the detector into a digital image.

Alternatively, and particularly when the secondary electrons are to be converted into an analog image, the image acquisition unit can also be a CCD sensor or a camera. The camera or the CCD sensor is designed to capture the analog image generated by the imaging unit and digitize it or convert it into a digital image.

Furthermore, the image acquisition unit can also be embodied as a unit that comprises a scintillator and a photomultiplier. It can also replace the detector of the SEM and supply an image signal to the evaluation unit.

A variant of the device is also advantageous where the image acquisition unit and the imaging unit are integrally formed with one another. Thus, the particles in the sample channel are enlarged according to the principle of the scanning electron microscope. The enlarged image is captured according to the principle of an iconoscope, orthicon, or superorthicon. Preferably, at least parts of the iconoscope/orthicon/superorthicon replace the detector of the SEM or a glass window of the iconoscope/orthicon/superorthicon is replaced by the sample channel with the raster section.

In a variant of the device where the SEM, as an imaging unit, and a superorthicon, as an image acquisition unit, are integrally formed with one another or the superorthicon also functions as a SEM, an evaluation unit for the secondary electrons is arranged in the vacuum chamber, which replaces the detector of the SEM. Instead of a glass window with a light-sensitive layer, as is common with conventional superorthicons, here there is the sample channel or the raster section of the sample channel. The section is formed at least in sections from the material (e.g., silicon nitride or aluminum foil) that can be penetrated by the primary electron beam and the secondary electrons. For this purpose, the raster section can have a plurality of thin sections (“windows”) measuring approx. 10 μm×10 μm with a thickness of approx. 10-30 nm. The SEM is designed such that imaging resolutions of up to 10 nm or more are possible. Additional electrodes and coils can be added for focusing, scanning, deflection or adjustment (fine adjustment) of the primary electron beam.

The SEM can also be designed such that anode voltages of up to 120 kV or more are possible at its primary electron source.

Furthermore, the image acquisition unit can transmit the image acquired in this manner to the evaluation unit electronically or by signaling technology. Both a still image and a moving image, such as a continuous video signal, can be transmitted to the evaluation unit.

For the purpose of analyzing and evaluating the transmitted image, the evaluation unit, according to one advantageous embodiment, has a data memory. Here, the morphological properties and, in particular, an appearance of the predetermined particles are stored, for example, by an algorithm, in tabular form, or as a comparative image. In addition, the evaluation unit uses image processing and object recognition as well as neural networks or artificial intelligence. This determines how many of the particles depicted in the image have morphological properties and, in particular, an appearance corresponding to the morphological properties and, in particular, the appearance of the predetermined particles and are therefore predetermined particles. Once the number of particles in the sample that are the predetermined particles has been determined in this manner, the proportion or number in the sample or in the air can be determined using the number.

The evaluation unit can also be formed by a plurality of computers that are networked with one another or implemented by a “cloud” solution. Accordingly, the evaluation or analysis carried out by the evaluation unit can also take place in the “cloud.”

According to another advantageous development, the device also has a radiation source to destroy particles. In particular, it destroys the predetermined particles. The radiation source is aligned with the sample channel so that the particles in the sample channel can be destroyed. The radiation source can be a deuterium lamp, for example, or, in particular, in the case of viruses as predetermined particles, a UV light source. Here, a UV light is generated that fragments the predetermined particles. As a result, the fragmentation or destruction of the predetermined particles can be recorded “live” or in real time using the SEM. Thus, the presence of predetermined particles in the sample can also be inferred through the evaluation by the evaluation unit of images captured in succession. To achieve this, the successively captured images can be compared by the evaluation unit. The number of predetermined particles in the sample can be deduced from the number of destroyed or fragmented particles. The comparison of a first image with an undestroyed particle to a second image, subsequently captured image with a destroyed particle and the resulting evaluation that the particle was a predetermined particle is also understood here as the detection and evaluation of morphological properties of the particle. Accordingly, the evaluation of the destructibility of particles provides an additional degree of freedom in determining the concentration of the predetermined particles in the air that can replace or supplement a comparison of the appearance of the particles in the image with previously known morphological properties.

If such a light-emitting radiation source is used, the light frequency, wavelength and/or light intensity of the radiation source can be adjustable. Thus, the fragmentation or destruction of the predetermined particles and/or the particles that are to be destroyed as predetermined particles can be adjusted.

Another aspect of the disclosure relates to a method for detecting a concentration of predetermined particles, particularly viruses, in air that comprises organic and/or inorganic aerosol particles using a device according to the disclosure. The aerosol particles contained in the air are bound in a fluid using the supply unit. Thus, the fluid contains the aerosol particles previously contained in the air as particles. A constant or uniformly clocked fluid flow is then provided along a predetermined flow path. An enlarged image of the particles contained in the fluid flowing through the sample channel is then generated by the imaging unit. The image generated in this manner is captured with the image acquisition unit and transmitted to the evaluation unit. The evaluation unit automatically detects morphological properties of the particles depicted in the image. The detected morphological properties are compared with morphological properties of the predetermined particles. The comparison determines a proportion of predetermined particles in the image and the concentration of the predetermined particles in the air. The detection of the morphological properties of the particles and the subsequent comparison is understood to mean, in particular, a comparison of the image generated by the imaging unit or the images of the particles shown thereon with comparative images of the predetermined particles.

In addition, another aspect of the disclosure relates to a system for determining a movement and concentration of predetermined particles in a space in the meaning of a room. The system comprises a central evaluation unit and a plurality of devices according to the disclosure. The devices are distributed in the space according to a predetermined pattern and, in particular, according to a predetermined raster. The central evaluation unit, which can also comprise the evaluation unit of the devices or form the same integrally, uses the concentrations respectively determined by the devices to generate a concentration of the particles in the space and/or a distribution of the predetermined particles in the space and/or to determine and/or predict a movement of the predetermined particles in the space. The concentrations can also be determined and observed or analyzed over a longer period of time, for this purpose. In particular, neural networks, artificial intelligence, or an extrapolation can also be used to determine the concentration of movements and the expected, i.e., future, behavior.

The movement of the predetermined particles can be understood to include not only the macroscopic movement in a space, but also, with a suitable arrangement of the devices, a Brownian molecular movement of the particles.

In addition to an alarm, which can be triggered when the concentration exceeds a preferably predetermined limit value, an alarm or signal can also be produced if the predetermined particle in the space, i.e., the aerosol cloud, moves in a certain direction or to a certain position.

The system is preferably designed to be so stable and autonomous that the system can function locally as a sensor.

The features disclosed above can be combined as required, provided this is technically possible and they do not contradict one another.

Further areas of applicability will become apparent from the description provided herein. The description and specific examples in this summary are intended for purposes of illustration only and are not intended to limit the scope of the present disclosure.

### DRAWINGS

Other advantageous refinements of the disclosure are characterized in the subclaims and/or depicted in greater detail below together with the description of the preferred embodiment of the disclosure with reference to the figures. In the drawing:

FIG. 1 is a schematic view of a first variant of the device.

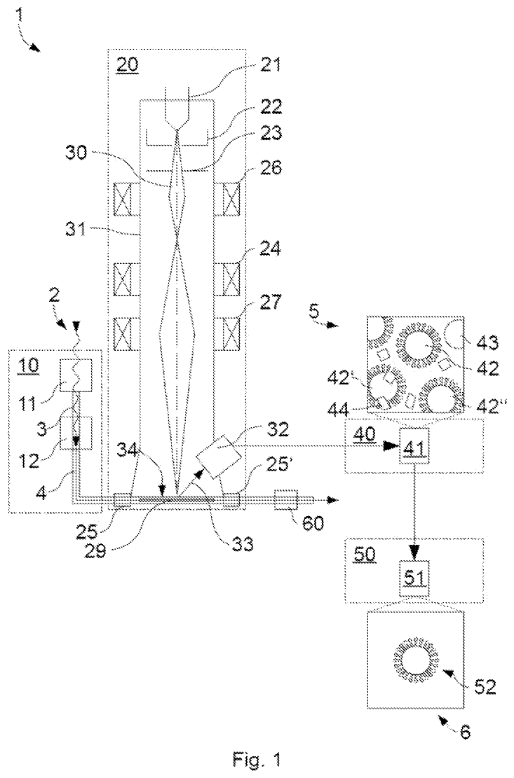

FIG. 2 is a schematic view of a second variant of the device.

### DETAILED DESCRIPTION

Example embodiments will now be described more fully with reference to the accompanying drawings.

The figures are schematic examples. The same reference symbols in the figures indicate same functional and/or structural features.

The basic principle of the device 1 is to suck in or take in air 3 and, for example, ambient air at an air inlet 2, to bind the particles contained in the air 3 in the supply unit 10 in a liquid 4 as a fluid. Also, the principle provides a constant flow of liquid or fluid through the imaging unit 20. The flow can be both continuous and clocked. This enables an “in situ analysis” to be carried out on the particles that are bound in the liquid 4. Thus, the sample to be analyzed, which is the liquid 4, or, more precisely, the liquid 4 flowing through the imaging unit 20, is changed continuously or in a clocked manner. Together with the liquid 4, a constant flow of particles is provided through the SEM or through the imaging unit 20. The particles are imaged in an enlarged manner so that the particles contained in the sample or in the liquid 4 can be subsequently analyzed.

In the present case, the supply unit 10 has a pre-filter 11 where particles are filtered from the air 3 which, due to their size, charge, or other factors, cannot be the predetermined particles. For this purpose, the pre-filter 11 has a plurality of filtering stages and apply different filtering principles.

The air 3 filtered through the pre-filter 11 is condensed by a condenser 12. Thus, a condensate forms as a liquid 4 where the particles previously contained in the filtered air 3 are bound.

The condensate or the liquid 4 is then pumped along a predetermined flow path from the supply unit 10 into or through the imaging unit 20. A pump 60 arranged on the output side of the imaging unit 20 is used for this purpose.

In the liquid 4, the predetermined particles and all of the particles contained therein are initially distributed relatively uniformly. Thus, the sought-after or predetermined particles whose concentration is to be determined in the air are evenly distributed over a region of the liquid 4 and are difficult or time-consuming to find. To improve and simplify the analysis, the imaging unit 20 has an isotachophoresis device with a first voltage terminal 25 and a second voltage terminal 25′. The first voltage terminal 25 is fluidically arranged on the input side of the imaging unit 20 or of the sample channel 29. The and the second voltage terminal 25′ is fluidically arranged at the output side of the imaging unit 20 or of the sample channel 29. The terminals 25, 25 build up an electric field in the sample channel 29 so that the liquid 4 flowing through the sample channel 29 form a plurality of regions. Each region has particles with the same or approximately the same ion mobility. Substantially all particles with an ion mobility equal to the ion mobility of the predetermined particles and consequently substantially all predetermined particles are located in one of these regions. Thus, it is sufficient to image only this region using the imaging unit 20 or to capture the same using the image acquisition unit 40 or to evaluate the same using the evaluation unit 50.

The imaging unit 20 instantiated as a SEM does not have to be designed for different measurement methods or an exchanging of sample carriers or the like. Thus, the SEM is specialized for the present application. For this purpose, the SEM has a completely and permanently sealed vacuum chamber 31. A vacuum (high vacuum) was generated once and is permanently maintained in the chamber 31. A primary electron beam 30 is emitted into the vacuum chamber, which can also be referred to as a measuring column, by a primary electron source 21 and runs through the length of the vacuum chamber 31. The beam intensity of the primary electron beam 30 is invariably set by a Wehnelt cylinder 22. It is guided or focused onto the sample channel 29 by a fixed and non-adjustable aperture 23 and a plurality of magnets 26, 27. Additionally or alternatively, the Wehnelt cylinder 22 can also be supplied with a fixed, unchangeable voltage and thus adjusted. The intensity of the primary electron beam 30 is set and the primary electron beam 30 focused in a fixed manner. A scanning device 24 guides the primary electron beam 30 in a raster pattern over a predetermined raster section 34 of the sample channel 29 to generate an enlarged image of the sample that is arranged in the sample channel 29. The scanning device 24 deflects the primary electron beam 30 according to a predetermined pattern. Thus, it scans the sample according to the predetermined raster.

The liquid 4 flowing through the sample channel 29 is thus always struck by the primary electron beam 30 in a single, predetermined manner. The secondary electrons 33 are generated that strike the detector 32 of the SEM and generate an image of the particles present in the liquid 4.

The secondary electrons 33 captured by the detector 32 can be converted into an analog image. It can then be converted into a digital image. Alternatively, the secondary electrons 33 or the image represented by the same can be converted directly into a digital image by the image acquisition unit 40 without generating an analog image as an intermediate step. The digital image is then transmitted to the evaluation unit 50.

A section 5 of an image generated by an A/D converter 41 where a multitude of particles are visible is shown by way of example. In particular, four predetermined particles 42, 42′, 42″ are shown by way of example and are only partially or covertly visible. These can also be overlaid by other particles 43, 44. Furthermore, the external appearance 52 of a predetermined particle is stored in the evaluation unit 50 or the data memory 51 as a comparative image 6 or as a morphological property of the predetermined particles. With the aid of image processing, the particles in the section 5 of the image are now compared with the external appearance 52 of the target particle or of the predetermined particle. If there is a sufficiently high degree of correspondence with the comparative image 6, the respective analyzed particle in the section 5 is identified as a predetermined particle and counted. The predetermined particles or viruses can thus be distinguished from other particles by their external appearance or by their external shape. For example, even though the particle 43 is approximately the same size, so that it would be incorrectly recognized as a virus or predetermined particle if it were determined on the basis of size, it has a completely different contour or surface shape. Thus, it can be correctly identified as a virus or as a predetermined particle using the device proposed herein and classified as not being a predetermined particle or virus.

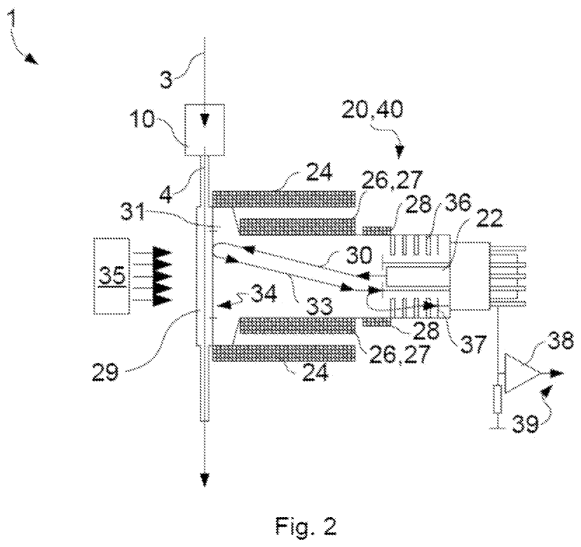

In FIG. 2, the imaging unit 20 and the image acquisition unit 40 are integrally formed with one another, for which reason the device 1 turns out to be an integration of a superorthicon and a SEM.

The basic structure of the device 1 according to FIG. 2 corresponds to that of a superorthicon, that is, to a vidicon with integrated evaluation (photomultiplier, electron multiplier) of the secondary electrons 33. The secondary electrons 33 are generated by the primary electron beam 30 according to the functional principle of a SEM.

Starting from a conventional superorthicon, the device 1 has a raster section 34 made of silicon nitride (SiN) instead of a glass window with a light-sensitive layer. The raster section 34 is embodied as a SiN plate having one or more regions (10 μm×10 μm) that can be referred to as windows. The thickness of the SiN plate or of the raster section 34, at least in the vicinity of the windows, is such that the primary electron beam 30 can reach the raster section 34 as far as the sample in the sample channel 29 directly adjoining the same to the rear and can scan it accordingly. A thickness of the “windows” that lies particularly in a range between 10 and 30 nm is advantageous for this purpose.

The rest of the construction of the device 1 or of the imaging unit 20 is selected such that resolutions of up to 10 nm and more are possible during imaging. This structure, which determines the resolution, is also determined particularly by the size of the raster section 34 and of the magnets 26, 27 for focusing.

In order to be able to provide the primary electron beam 30 with sufficient precision for the scanning or for the enlargement of the particles contained in the sample, the device 1 or the imaging device 20 can have additional electron lenses. It may include further magnets or coils 26, 27 that act as a lens for the primary electron beam 30.

In order to make fine adjustment possible, the present device has magnets or, in this case, coils 28 to adjust the primary electron beam 30. The structure is advantageously designed in such a way that anode voltages of up to 120 kV or more are possible.

The primary electron beam 30 generated by the Wehnelt cylinder 22 is deflected by the raster unit, formed particularly by the magnets or coils 24, according to a predetermined raster pattern. The beam 30 is guided over the raster section 34. As an alternative to deflection by coils, the raster unit can be designed to deflect the primary electron beam 30 electrostatically. The secondary electrons 33 generated as a result are then detected by the dynodes 36 as part of the photomultiplier and of the signal anode 37, which replace or form the detector 32 of the SEM.

The signal detected by the signal anode 37 is then amplified with the signal amplifier 38 and forwarded as an image signal 39 to the evaluation unit 50 (not shown in FIG. 2).

In order to be able to also determine, on the basis of the captured images, which of the particles in the image are the predetermined particles, the device 1 according to FIG. 2 has a radiation source 35. The radiation source 35 generates radiation that fragments the predetermined particles and thus destroys them. If the predetermined particles are viruses, the radiation source 35 generates UV light. The UV light causes the viruses to vibrate and thereby breaks them open. Thus, it is possible to determine which particles have been destroyed on the basis of a plurality of successively captured images. The destroyed or fragmented particles are the predetermined particles. Thus, the number in the images and the concentration in the air can be determined.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device for detecting a concentration of predetermined particles, particularly viruses, in air that includes organic and/or inorganic aerosol particles, comprising:
a supply unit, an imaging unit, an image acquisition unit, and an evaluation unit;
the supply unit binds the aerosol particles contained in the air in a fluid, the fluid contains aerosol particles that were previously contained in the air as particles, and a constant or uniformly clocked fluid flow bypass along a predetermined flow path;
the imaging unit has a sample channel, the interior can be flowed through by the fluid and determines the predetermined flow path within the imaging unit, and the imaging unit scans the particles in the fluid in the sample channel in a raster pattern using an electron beam as the primary electron beam, to capture electrons that are designated as secondary electrons through interaction of the electron beam with the particles and, by means of the captured electrons, to generate an enlarged image of the particles that are contained in the fluid flowing through the sample channel;
the image acquisition unit acquires the image and transmit the image to the evaluation unit; and
the evaluation unit automatically acquires morphological properties of the particles shown in the image, to compare the detected morphological properties with morphological properties of the predetermined particles, and to determine a proportion and/or a number of predetermined particles in the image and the concentration of the predetermined particles in the air by comparison.

2. The device as set forth in claim 1, wherein the imaging unit has a primary electron source that generates a primary electron beam, a plurality of magnets that direct the primary electron beam and act as a lens for the primary electron beam, at least one raster device for deflecting the primary electron beam in a raster pattern, a detector for detecting secondary electrons, and a vacuum chamber with a vacuum prevailing therein that is traversed by the primary electron beam,
the sample channel passes through the vacuum chamber or adjoins the vacuum chamber and is arranged in or at the vacuum chamber in such a way that the primary electron beam strikes the sample channel and the fluid flowing through the sample channel, so that secondary electrons are generated.

3. The device as set forth in claim 1, wherein the sample channel is made at least partially of silicon nitride, aluminum foil, or another material that is permeable to the primary electron beam and to the secondary electrons and simultaneously seals the interior of the sample channel off from the vacuum chamber in a pressure-tight manner.

4. The device as set forth in claim 2, wherein the sample channel has a raster section on a side facing toward the primary electron beam over which the primary electron beam is deflected in a raster pattern by the raster device, and in the raster section, the sample channel is made of silicon nitride, aluminum foil, or another material that is permeable to the primary electron beam and to the secondary electrons that simultaneously seals the interior of the sample channel off from the vacuum chamber in a pressure-tight manner.

5. The device as set forth in claim 2,
wherein the magnets embodied as permanent magnets or as electromagnets and supplied with a constant voltage, so that the primary electron beam is focused by the magnets in a single, predetermined manner on the fluid flowing through the sample channel,
the sample channel is permanently connected to the vacuum chamber,
the vacuum chamber is completely sealed in a pressure-tight manner and designed to permanently maintain a vacuum prevailing therein, so that a pressure reduction that determines the vacuum need only be carried out once.

6. The device as set forth in claim 2,
wherein the raster device is designed to deflect the primary electron beam electrostatically and/or electromagnetically.

7. The device as set forth in claim 1,
wherein the image acquisition unit is an A/D converter that converts an analog image acquired by secondary electrons by the detector into a digital image.

8. The device as set forth in claim 1,
wherein the image acquisition unit and the imaging unit are integrally formed with one another, so that the particles in the sample channel are enlarged according to the principle of the scanning electron microscope and the enlarged image is captured according to the principle of an iconoscope, orthocon, or superorthicon.

9. The device as set forth in claim 1,
wherein the evaluation unit has a data memory where the morphological properties and, in particular, an appearance of the predetermined particles are stored, and the evaluation unit determines, by image processing and object recognition, how many of the particles depicted in the figure have morphological properties and, in particular, an appearance corresponding to the morphological properties and, in particular, the appearance of the predetermined particles and are thus predetermined particles.

10. The device as set forth in claim 1,
further comprising a radiation source for destroying particles, and particularly for destroying the predetermined particles,
the radiation source aligned with the sample channel so that the particles in the sample channel can be destroyed.

11. A method for detecting a concentration of predetermined particles, particularly viruses, in air that comprises organic and/or inorganic aerosol particles, with a device according to claim 1, comprising:
binding the aerosol particles contained in the air in a fluid using the supply unit so that the fluid contains the aerosol particles previously contained in the air as particles;
generating a constant or uniformly clocked fluid flow along a predetermined flow path;
the imaging unit generating an enlarged image of the particles that are contained in the fluid flowing through the sample channel;
capturing the image with the image acquisition unit and transmitting the image to the evaluation unit;
the evaluation unit automatically capturing morphological properties of the particles depicted in the image and comparing the captured morphological properties with morphological properties of the predetermined particles; and
determining a proportion and/or a number of predetermined particles in the image and the concentration of the predetermined particles in the air by the comparison.

12. A system for determining a movement and concentration of predetermined particles in a space, comprising a central evaluation unit and a plurality of devices according to claim 1, and
distributing the devices in the space according to a predetermined pattern and, in particular, according to a predetermined raster pattern, and
the central evaluation unit uses the concentrations, respectively, determined by the devices generating a concentration of the particles in the space and/or a distribution of the predetermined particles in the space and/or to determining and/or predicting a movement of the predetermined particles in the space.
